(19) United States
(12) Patent Application Publication
(10) Pub. No.: US 2002/0080238 A1
(43) Pub. Date: Jun. 27, 2002

(54) Watching system

(75) Inventor: Akira Ohmura, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/026,904

(22) Filed: Dec. 27, 2001

(30) Foreign Application Priority Data
Dec. 27, 2000 (JP) 2000-399503
Dec. 27, 2000 (JP) 2000-399504
Dec. 27, 2000 (JP) 2000-399505
Dec. 27, 2000 (JP) 2000-399506

(51) Int. Cl. H04N 9/47

(52) U.S. Cl. 348/143; 386/38

(57) ABSTRACT

A watching system has a watching camera that takes pictures of a field to output image data. The watching system records image data in a disk recorder which records conventional broadcast program. The watching system transmits the image data to a mobile terminal. The watching system prefers an internal call to a public call. The watching system carries out a management against a danger when a suspected person is detected. The watching system changes the management according to the detected time. The watching system changes the management according to whether or not anyone is at home.

### BACKGROUND OF THE INVENTION

This application is based upon and claims priority of Japanese Patent Applications No. 2000-399503 filed on Dec. 27, 2000, No. 2000-399504 filed on Dec. 27, 2000, No. 2000-399505 filed on Dec. 27, 2000, and No. 2000-399506 filed on Dec. 27, 2000, the contents being incorporated herein by reference.

1. Field of the Invention

The invention relates to a watching system, and more particularly to a watching system for avoiding the calamity in a house.

2. Description of Related Art

In this field of the art, various types of watching system have been proposed for a home security.

There have been proposed various improvements in the field of watching system, such as in Japanese Laid-Open Patent Applications No. 9-224238, No. 2000-40196, and No. 2000-222658. However, there have been problems and disadvantages still left in the related arts.

For example, a watching system is proposed to be connected to a television set and a home video tape recorder. Such a watching system, however, dose not provide any management for user to avoid a danger detected by the watching system.

A watching system on the other hand is proposed to be connected to a mobile phone by means of a public call. However, this costs users considerably.

### SUMMARY OF THE INVENTION

In order to overcome the problems and disadvantages, the invention provides an watching system comprising a watching camera that takes pictures of a field to output image data and a disk recorder that records conventional broadcast program data in a disk memory. The watching system further comprises a controller that controls the disk recorder to record the image data into the disk memory. This feature is quite advantageous to compose the watching system with a low cost.

The invention further provides a watching system comprising a mobile terminal and a watching camera. The mobile terminal is capable of a first wireless communication on the public call and a second wireless communication on an internal call. The watching camera takes pictures of a field to output image data. The watching system further comprises a remote communication equipment capable of transmitting the image data to the mobile terminal through one of the first and second wireless communications. This feature is quite advantageous for the mobile terminal to get information from the watching camera.

According to another feature of the invention, a watching system comprises a mobile terminal capable of a first wireless communication on the public call and a second wireless communication on an internal call and a watching camera that takes pictures of a field to output image data. The watching system further comprises a remote communication equipment capable of responding to the watching camera to transmit a signal to the mobile terminal through one of the first and second wireless communications.

According to still another feature of the invention, a watching system comprises a watching camera that takes pictures of a field to output image data and a monitor that displays conventional broadcast program. The watching system further comprises a controller that controls the monitor to display the image data and a management information against a danger. This feature makes it easy for a user to avoid a danger.

According to further feature of the invention, a watching system comprises a watching camera that takes pictures of a field to output image data and an acquisition equipment that acquires information relating to time. The watching system further comprises a controller that carries out a management against a danger depending on the image data and the information. This feature makes it possible to avoid a danger.

According to still further feature of the invention, a watching system comprises a watching camera that takes pictures of a field to output image data and a detector that detects whether or not anyone is at home. The watching system further comprises a controller that carries out a management against a danger depending on the image data of the watching camera and the detection by the detector. This feature makes it possible to avoid a danger automatically.

Other features and advantages according to the invention will be readily understood from the detailed description of the preferred embodiment in conjunction with the accompanying drawings.

### BRIEF DESCRIPTION OF THE DRAWINGS

FIG. 1 represents a block diagram of a watching system.

FIG. 2 represents a flowchart of the main function of Set Top Box.

FIG. 3 represents a flowchart showing the function of STB for controlling hard disk recorder.

FIG. 4 represents a display on the television monitor for showing an example of icons and file names for the stored image data.

FIG. 5 represents a flowchart showing the function of STB for the above mentioned “television control” relating to the control of television set.

FIG. 6 represents a display on the television monitor for showing an example of the indication of the menu.

FIG. 7 represents a flowchart showing the function of STB for controlling mobile phone.

FIG. 8 represents a flowchart showing the function of mobile phone for controlling STB.

FIG. 9 represents a flowchart showing the function of STB for the alarm control.

### DETAILED DESCRIPTION OF THE PREFERRED EMBODIMENT

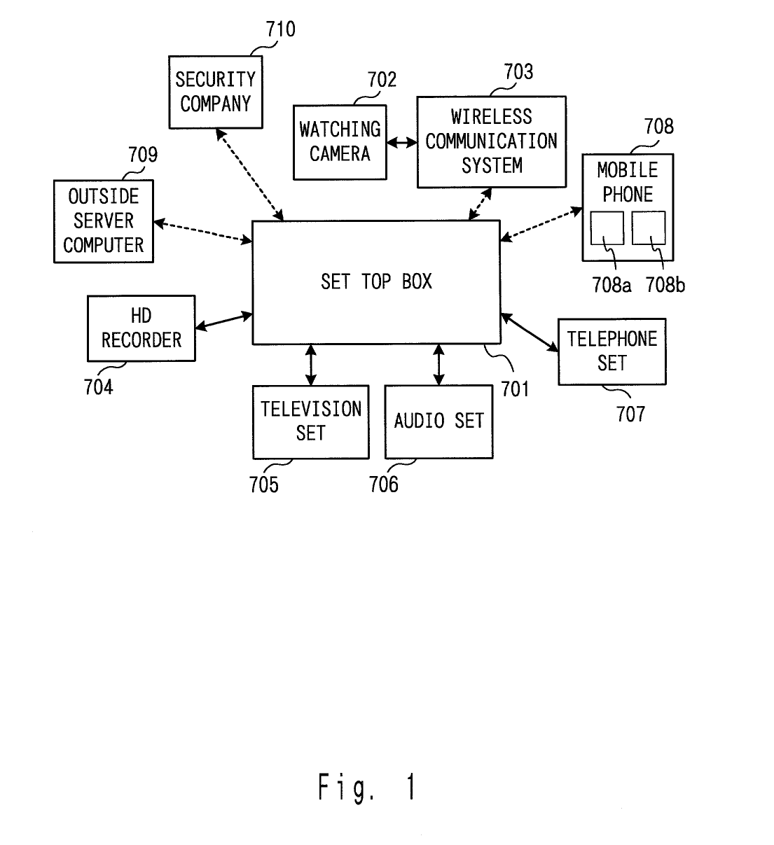

FIG. 1 represents a block diagram of a watching system according to an embodiment of the present invention. The watching system is for the home security. Set Top Box (herein after referred to as “STB”) 701 is for receiving signals from any place inside and outside the home. STB 701 also serves as a central controller for various digital electrical appliances in the home. Alternatively, such a central controller may be prepared outside STB 701 in digital communication therewith. Watching camera 702 is connected to STB 701 so as to work in accordance with conditions set in STB 701. Through the connection with STB 701, watching camera 702 can cooperate with digital electrical appliances controlled by STB 701 to achieve various sophisticated functions.

According to the third embodiment, STB 701 is connected with hard disk (HD) recorder 704, television set 705, audio set 706, and telephone set 707. STB is further in wireless connection with mobile phone 708, and capable of communicate with security company 710 and outside server computer 709. Thus, STB 701 can report an emergency to security company 710 directly or by way of telephone set 707.

In detail, the connection of watching camera 702 to STB 701 is through wireless communication system 703 on Bluetooth by means of coupling watching camera 702 to wireless communication system 703 at a connector. Thus, watching camera 702 and STB 701 communicate with each other on Bluetooth. Mobile phone 708 also includes wireless communication system 708a on Bluetooth in addition to public mobile phone communication system 708b for communicate with STB 701 on either system. However, a simplified modification of the embodiment may be possible, in which any element such as HD recorder 704 would be omitted if the system need not the element.

According to the watching system in FIG. 1, the images taken by watching camera 702 is recorded in HD recorder 704 for a proof or an inspection. HD recorder 704 is originally provided for the purpose of recording conventional broadcast program received by television set 705. Such a common use of HD recorder 704 makes it unnecessary to prepare any additional HD recorder for the exclusive use in watching system.

HD recorder 704 has a buffer memory with a capacity of temporarily storing a given length of the latest movie image data, which is continuously substituted by the current image data from watching camera 702. When a suspected person is detected, an image data of a predetermined period back is transmitted from the buffer memory to HD recorder 704 at once with the succeeding image data from watching camera 702 also is being recorded in HD recorder 704. Thus, the continuous action of the suspected person before and after the detection is recorded in HD recorder 704. In a modification of the embodiment, the function of the buffer memory is replaced by a capacity of HD recorder 704 itself to omit the adoption of the buffer memory.

If there will be no more room left in capacity of HD recorder 704 to continue the recording of the image data from watching camera 702, the image data is transmitted to outside server computer 709 through the telecommunication network. Such a transmission of the image data from watching camera 702 to outside server computer 709 is also available in case HD recorder 704 is occupied by a task of recording a broadcast program from television set 705. Alternatively, HD recorder 705 may prefer the recording of the image data from watching camera 702 with the recording of the broadcast program intermitted. Or, HD recorder 705 may simultaneously record both the image data from watching camera 702 and broadcast program from television set 705 in a dual image mode.

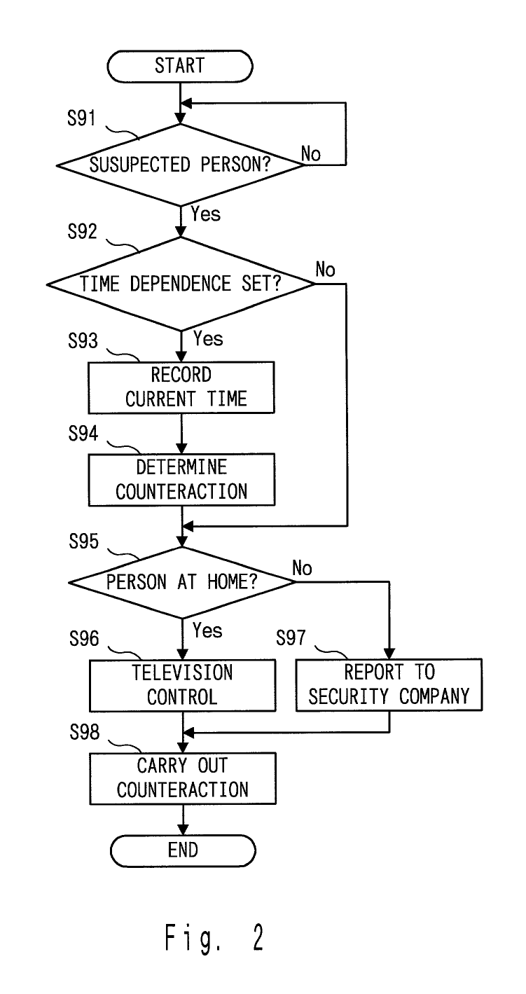

FIG. 2 represents a flowchart of the main function of STB 701. The flow is always in operation as long as watching camera 702 is effective.

In step S91, it is checked whether or not a signal is received from watching camera 702 reporting that a suspected person is detected. If the signal is received, the flow advances to step S92. On the other hand, step S91 is repeated unless the signal is received.

The flow beginning from step S92 is for carrying out various counteractions to be taken depending on various settings in case a suspected person is detected. In step S92, it is checked whether or not a time dependence setting has been made. According to the time dependence setting, the counteraction to be taken differs depending on the time when a suspected person is detected. For example, “television control” to be explained later is carried out if a suspected person is detected within a period from 8:00 a.m. till 10:00 p.m., while an instant report to security company 710 or the police is carried out if a suspected person is detected within the other period of the day. The customer at home has made such a time dependence setting.

If it is determined in step S92 that the time dependence setting has been made, the flow advances to step S93. On the other hand, the flow goes to step S95 in case of no time dependence setting. In step S93, the current time is recorded, and a counteraction to be taken is determined in step S94 in dependence on the time recorded in step 93 is made.

For example, if the time recorded in step S93 is 11:00 a.m., STB 701 determines “television control” on the image data. On the other hand, STB 701 determines to instantly report to security company 710 if the time recorded in step S93 is 11:00 p.m. The difference in the above counteractions depends on the possibility of suspicion against a person visiting home in the daytime or the nighttime. In other words, there would be less suspicion against a person visiting home by day, such as a mail carrier or a newspaper deliverer. In contrast to that, a higher possibility of suspicion would be caused against a parson visiting home at late night. Further, it is possible in daytime to quickly report to security company 710 on necessity after confirming a visitor through “television control”. But, such a confirmation or quick action would not be possible at late night when family is all sleeping.

In step S95, it is checked whether or not a responsible member of family is at home. A switch to be manually operated by the family may be located at the home entrance for generating information of presence or absence for the purpose of the check in step S95. Alternatively, a sensor may be located at the home entrance to automatically generate the information of presence or absence. Even in a case of a presence of a child who cannot properly respond to a suspected person, it should be determined in step S95 that no responsible member is not at home. The manual switch or the automatic sensor is designed to fulfil this requirement.

If it is determined in step S95 that a responsible member is at home, the flow advances to step S96. On the other hand, the flow goes to step S97 in case of no responsible member at home.

In step S96, a counteraction to be taken with a responsible person at home is determined. On the other hand, a counteraction to be taken with no responsible person at home is determined in step S97. For example, in step S96, STB 701 determines “television control” on the image data. On the other hand, STB 701 determines to instantly report to security company 710 in step S97. The difference in the above counteractions depends on the capability of the counteraction. In other words, it is possible for someone at home to confirm a suspected person, while such a confirmation is impossible in the case of no one at home.

In step S98, the counteraction is finally determined in view of the combination of the determination in steps S94, S96 and S97. And, the finally determined counteraction is carried out. In addition to the above mentioned “television control” and the instant report to the security company, the final determination on the counteraction includes various operations, the details of which will be described later.

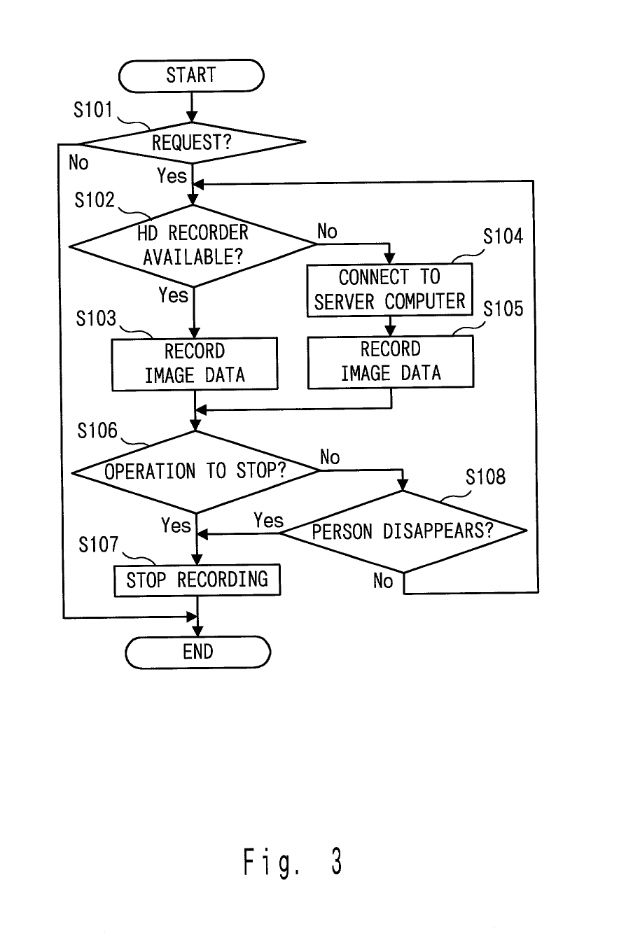

FIG. 3 represents a flowchart showing the function of STB 701 for controlling HD recorder. In step S101, it is checked whether or not the determination in steps S94, S96 and S97 in FIG.2 includes a request for HD recorder 704 to record the image signal when a suspected person is detected by watching camera 702. If it is determined in step S101 that the determination includes the request, the flow advances to step S102. On the other hand, the flow goes to the end of the flow in case of no request.

In step S102, it is checked whether or not HD recorder 704 is available. For example, it is determined that HD recorder 704 is not available if there is no more room left in capacity of HD recorder 704 or HD recorder 704 is occupied by a task of recording a broadcast program or the like. If it is determined that HD recorder is available, the flow advances to step S103, in which an image data in the buffer memory is transmitted to HD recorder 704 with the recording by HD recorder 704 of the succeeding image data from watching camera 702 started.

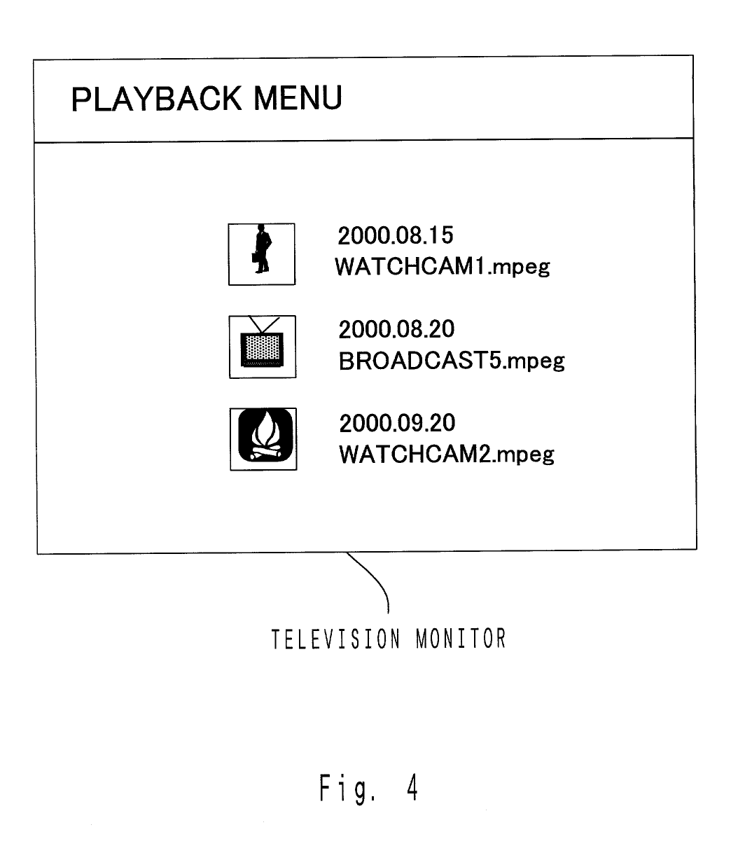

The image data from watching camera 702 is recorded so as to be easily distinguished from the ordinary image data of the broadcast program. For example, a file name with characters suggesting the watching camera is given to the recorded image data or the icon for the watching camera data is differentiated from that for the ordinary broadcast program data. FIG. 4 represents a display on the television monitor for showing an example of icons and file names for the stored image data, in which icons and file names for the watching data are easily distinguishable from those for the ordinary broadcast program data. This is advantageous in finding or retrieving a desired image data of the watching camera among the recorded files in HD recorder 704 even if it stores a great number of ordinary broadcast image files. For convenience, it is recommendable to record a series of plurality of image data successively taken by watching camera 702 as the form of a single file.

If it is determined in step S102 in FIG. 3 that HD recorder is not available, the flow advances to step S104, in which STB 701 connects a predetermined server computer through telephone set 707. And, in step S105, an image data in the buffer memory is transmitted to the server computer with the recording by the server computer of the succeeding image data from watching camera 702 started.

In any case, it is checked in step S106 whether or not a manual operation is made to stop recording the image data of watching camera 702. If it is determined that the manual operation to stop is made, the flow advances to step S107, in which the recording is stopped. On the other hand, the flow goes to step S108 if it is checked in step S106 that no operation to stop is manually made. In step S108, it is checked whether or not watching camera 702 reports that the suspected person disappears. If it is determined that the suspected person disappears, the flow goes to step S107 to automatically stop the recording. On the other hand, the flow goes back to step S102 if the suspected person is still detected. Thus, the recording by HD recorder 704 or by the server computer is continued unless the manual operation to stop is made or the suspected person disappears.

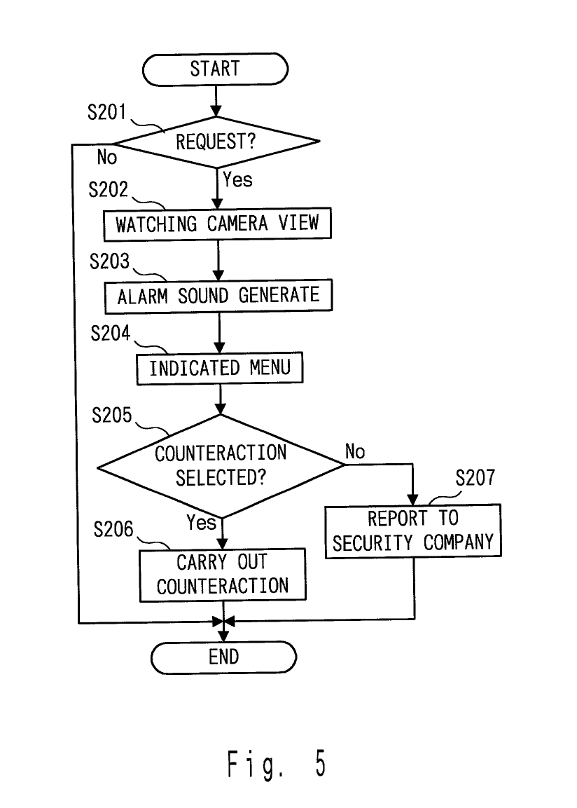

FIG. 5 represents a flowchart showing the function of STB 701 for the above mentioned “television control”, relating to the control of television set 705. In step S201, it is checked whether or not the determination in steps S94, S96 and S97 in FIG.2 includes the television control, in which television set 705 is requested to display on its monitor the image data form watching camera 702 when a suspected person is detected. If it is determined in step S201 that the determination includes the television control, the flow advances to step S202. On the other hand, the flow goes to the end of the flow in case of no inclusion of the television control.

In step S202, television set 705 is automatically turned on if it has been in off state. Such a sudden activation of the television set 705 with a voice or music from its speaker would call attention to the family at home. The voice or music raised by television set 705 would mislead the outside suspected person as if the family is at home even if the family is really not at home, which would discourage the suspected person from illegally coming into the house.

On the other hand, the monitor display is forcibly switched from the ordinary broadcast program to the watching camera view if television set 705 has already been watched by the family at home.

In step S203, television set 705 further generates an alarm sound from its speaker to call an additional attention to either family inside or the suspected person outside.

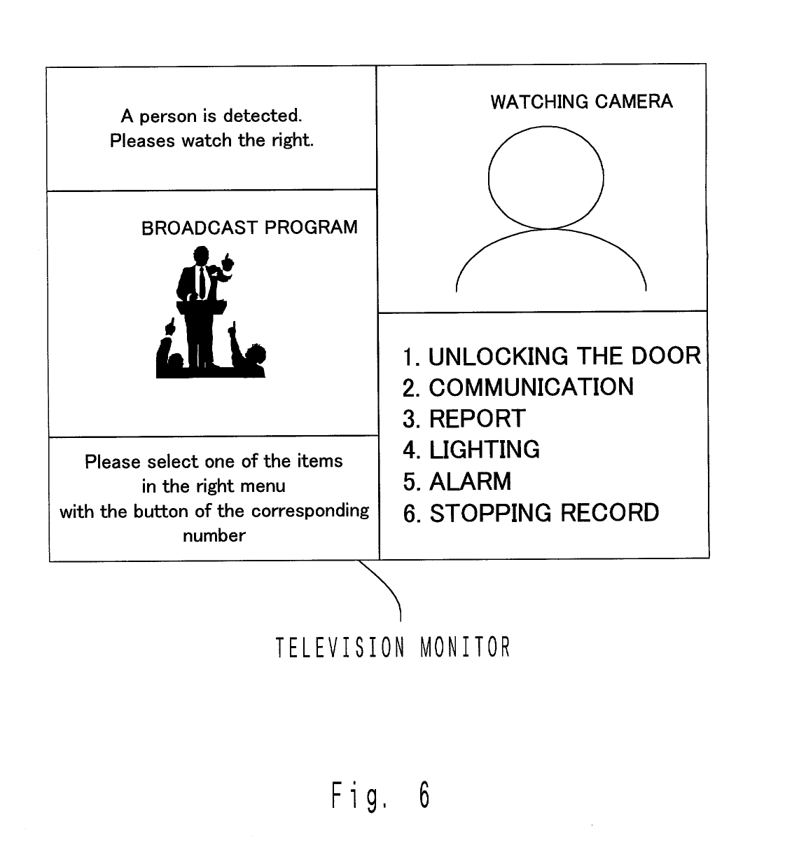

In step S204, a menu of selective counteractions is indicated on the monitor of television set 705 in addition to the image from watching camera 702. FIG.6 represents a display on the television monitor for showing an example of the indication of the menu.

Among the counteractions in the menu in FIG.6, “Unlocking the Door” is the counteraction to be selected if the person taken by watching camera 702 is identified as a safe familiar one on the monitor of television set 705. In response to the selection of this counteraction, the door is actually unlocked. “Communication” is the counteraction to be selected if the family feel a necessity to talk to the person taken by watching camera 702. “Report” is the counteraction to be selected if the family feel a necessity to report to security company 710 or the police of the suspected person taken by watching camera 702. “Lighting” is the counteraction to be selected if the family feel a necessity of turning on a strong light at the entrance. “Alarm” is the counteraction to be selected if the family feel a necessity to turn on the alarm located at watching camera 702. “Lighting” and “Alarm” are for discouraging the suspected person from committing a possible crime. Finally, “Stopping Record” is the counteraction to be selected if the family feel no necessity to continue recording the image data form watching camera 702 since the person is identified with no suspicion. The selection among the above mentioned counteractions is made by pushing one of predetermined channel buttons on the television remote controller.

In step S205, it is checked whether or not the selection of the counteraction is made within a predetermined time period starting from the indication of the menu in step S204. If the selection is made, the flow advances to step S206, in which the selected counteraction is carried out with television set 705 returned into the original condition on the termination of the counteraction. On the other hand, if no selection is manually made within the predetermined time period, the flow goes to step S207, in which the report to a predetermined security company or the police is automatically made.

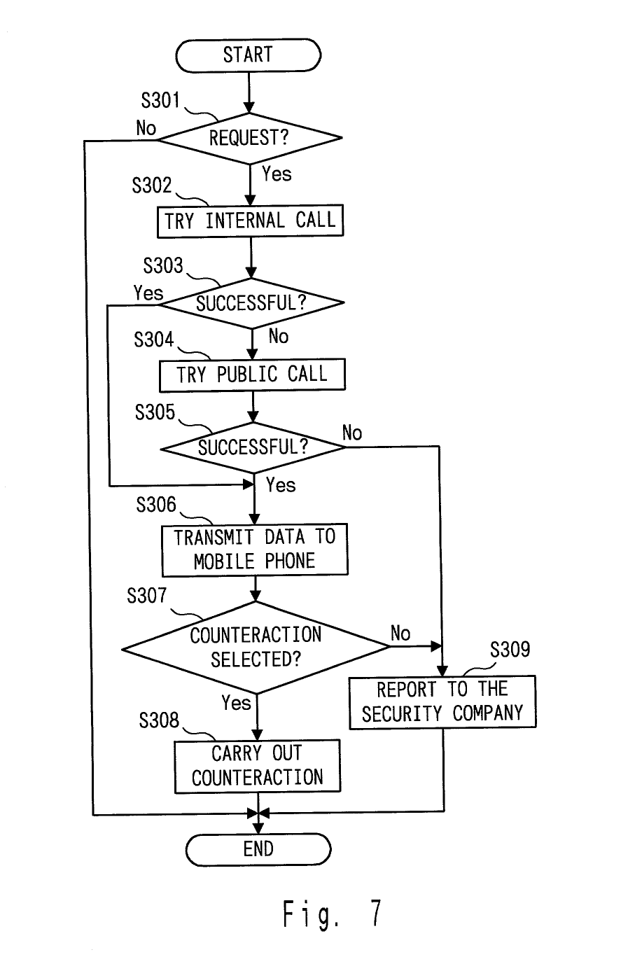

FIG. 7 represents a flowchart showing the function of STB 701 for controlling mobile phone 708. In step S301, it is checked whether or not the determination in steps S94, S96 and S97 in FIG.2 includes a request for STB 701 to report to mobile phone 708 when a suspected person is detected by watching camera 702. If it is determined that the determination includes such a request, the flow advances to step S302. On the other hand, the flow goes to the end of the flow in case of no inclusion of the request.

In step S302, STB 701 tries an “internal call” to mobile phone 708. The “internal call” means a call not through the public mobile phone communication system 708b, but through personal wireless communication system 708a on Bluetooth or a wireless home local area network (LAN). If such an internal call is successful, a high speed and high reliability data communication is possible without charge.

In step S303, it is checked whether or not the internal call is successful. If it is determined in step S303 that the internal call finally resulted in failure, the flow instantly advances to step 304. In step S304, STB 701 makes a public call to mobile phone 708 through public mobile phone communication system 708b as the second priority try. On the other hand, step S304 is omitted if it is determined in step S303 that the internal call as the first priority try is successful.

In step S305, it is finally checked whether or not the call to mobile phone 708 is successful in any way. If it is determined that STB 701 successfully connects with mobile phone 708, the flow advances to step S306. On the other hand, if it is determined in step S305 that the call to mobile phone 708 finally resulted in failure, the flow goes to step S309, in which the report to a predetermined security company or the police is automatically made. In step S305, even a successful connection to the answerphone is considered as the failure in connection. This is because a connection to the answerphone would not lead to a proper counteraction in case of emergency.

In step S306, STB 701 transmits to mobile phone 708 the image data from watching camera 702 as well as the menu of selective counteractions as in FIG. 6, which are indicated by mobile phone 708 on its LCD monitor.

In step S307, it is checked whether or not the selection of the counteraction is made within a predetermined time period starting from the indication of the menu in step S306. If the selection is made, the flow advances to step S308, in which the selected counteraction is carried out with mobile phone 708 disconnected on the termination of the counteraction. On the other hand, if no selection is manually made within the predetermined time period, the flow goes to step S309, in which the report to the security company or the police is automatically made.

STB 701 can be designed to simultaneously make the same report of the image data from watching camera 702 with the menu of counteractions to a plurality of monitors, such as of television set 705 and of mobile phone 708. In this case, once the selection among the menu of counteractions is made on one of the monitors, the report to other monitors is instantly terminated.

The personal wireless communication system of mobile phone 708 in the above embodiment is not limited to Bluetooth, but any other types of wireless home local area network (LAN) is possible. Further a plurality of personal wireless communication systems may be adopted and suitably selected. The order of priority on such a plurality of communication systems can be preset according to a system such as IEEE802.11e with the possible emergency and cost taken into consideration.

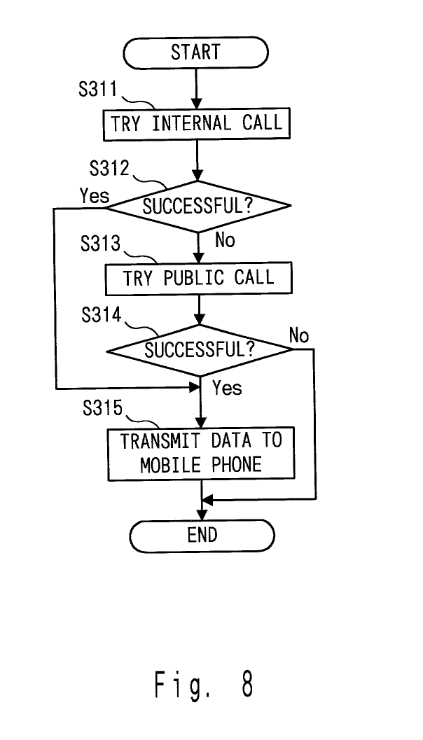

FIG. 8 represents a flowchart showing the function of mobile phone 708 for controlling STB 701. In addition to accepting information from STB 701 as in FIG. 7 it is possible for mobile phone 708 to make a call to STB 701 for getting information.

In step S311, mobile phone 708 tries an “internal call” to STB 701. In step S312, it is checked whether or not the internal call is successful. If it is determined in step S312 that the internal call finally resulted in failure, the flow instantly advances to step 313. Instep S313, mobile phone 708 makes a public call to STB 701 through public mobile phone communication system 708b as the second priority try. On the other hand, step S313 is omitted if it is determined in step S312 that the internal call as the first priority try is successful.

In step S314, it is finally checked whether or not the call to STB 701 is successful in any way. If it is determined that mobile phone 708 successfully connects with STB 701, the flow advances to step S315. In step S315, STB 701 transmits to mobile phone 708 the image data from watching camera. After the transmission of the image data the flow goes to the end of the flow. On the other hand, if it is determined in step S314 that the call to STB 701 finally resulted in failure, the flow directly goes to the end of the flow.

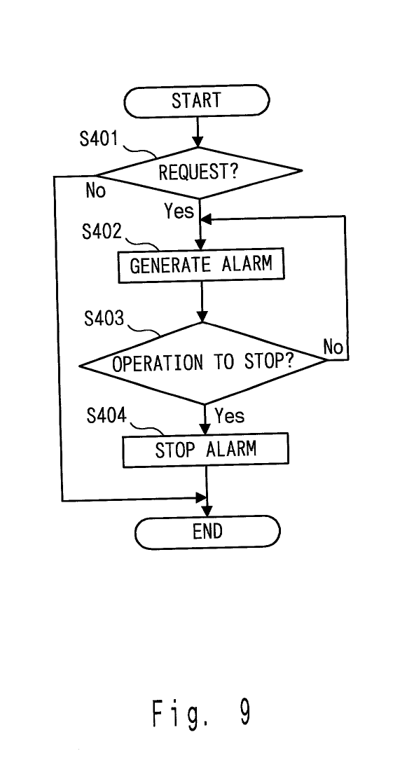

FIG.9 represents a flowchart showing the function of STB 701 for the alarm control. In step S401, it is checked whether or not the determination in steps S94, S96 and S97 in FIG. 2 includes the request of generating an alarm when a suspected person is detected by watching camera 702. If it is determined in step S401 that the determination includes the request of alarm, the flow advances to step S402. On the other hand, the flow goes to the end of the flow in case of no inclusion of such a request of alarm.

In step S402, a preset alarm or a combination of alarms is generated. The alarm preset may be possible by selecting one or combination of a plurality of alarm menu, such as the lighting at entrance, generation of sound at the watching camera 702, and generation of sound by audio set 706 or the like. In step S403, it is checked whether or not a manual operation to stop the alarm is made. If the operation is made, the flow goes to step S404 to stop the alarm. On the other hand, the flow goes back to step S402 to continue the alarm unless it is determined in step S403 that the manual operation is made.

What is claimed is:

1. A watching system comprising:
a watching camera that takes pictures of a field to output image data;
a disk recorder that records conventional broadcast program data in a disk memory; and
a controller that controls the disk recorder to record the image data into the disk memory.

2. The watching system according to claim 1, wherein the disk memory in the disk recorder includes a hard disk driver.

3. The watching system according to claim 1, wherein the disk recorder makes the image data distinguishable from the broadcast program data upon recording the data.

4. The watching system according to claim 1 further comprising a first input for the broadcast program data and a second input for the image data.

5. The watching system according to claim 4, wherein the controller is adapted to switch between the first and second inputs to be effective to record the data into the disk memory.

6. A watching system comprising:
a mobile terminal capable of a first wireless communication on the public call and a second wireless communication on an internal call;
a watching camera that takes pictures of a field to output image data; and
a remote communication equipment capable of transmitting the image data to the mobile terminal through one of the first and second wireless communications.

7. The watching system according to claim 6, further comprising a controller that makes a first try with the second wireless communication and a second try with the first wireless communication if the first try results in fail.

8. The watching system according to claim 7, wherein the controller is located in the mobile terminal.

9. The watching system according to claim 7, wherein the controller is located in the remote communication equipment.

10. The watching system according to claim 6, wherein the second wireless communication is on a wireless local area network.

11. The watching system according to claim 6, wherein the mobile terminal is capable of transmitting a command to the remote communication equipment through one of the first and second wireless communications.

12. A watching system comprising:
a mobile terminal capable of a first wireless communication on the public call and a second wireless communication on an internal call;
a watching camera that takes pictures of a field to output image data; and
a remote communication equipment capable of responding to the watching camera to transmit a signal to the mobile terminal through one of the first and second wireless communications.

13. The watching system according to claim 12, further comprising a controller that makes a first try with the second wireless communication and a second try with the first wireless communication if the first try results in fail.

14. The watching system according to claim 12, wherein the second wireless communication is on a wireless local area network.

15. The watching system according to claim 12, wherein the mobile terminal is adapted to put a higher priority on the signal from the remote communication equipment than any other call.

16. The watching system according to claim 12, wherein the remote communication equipment is adapted to transmit the image data of the watching camera.

17. The watching system according to claim 12, wherein the mobile terminal has a monitor device which displays the signal from the remote communication equipment.

18. The watching system according to claim 17, wherein the signal from the remote communication equipment is the image data of the watching camera.

19. The watching system according to claim 12, wherein the remote communication equipment includes a detector that detects a predetermined condition on the image data to generate the signal to be transmitted to the mobile terminal.

20. The watching system according to claim 12, wherein the mobile terminal is capable of transmitting a command to the remote communication equipment through one of the first and second wireless communications.

21. The watching system according to claim 12, wherein the mobile terminal is a mobile phone.

22. A watching system comprising:
a watching camera that takes pictures of a field to output image data;
a monitor that displays conventional broadcast program;
a provider that provides a management information against a danger; and
a controller that controls the monitor to display the image data and the management information.

23. The watching system according to claim 22, wherein the controller is adapted to control the monitor to display the image data and the management information when the controller detects a predetermined condition on the image data.

24. The watching system according to claim 23, wherein the predetermined condition is an appearance of a predetermined object in the image data.

25. The watching system according to claim 22, wherein the management information includes a report of the danger to a predetermined place.

26. The watching system according to claim 22, wherein the management information includes a plurality of selectable counteractions to the danger.

27. The watching system according to claim 26, wherein the controller is adapted to require a choice among the plurality of selectable counteractions.

28. A watching system comprising:
a watching camera that takes pictures of a field to output image data;
an acquisition equipment that acquires information relating to time; and
a controller that carries out a management against a danger depending on the image data and the information.

29. The watching system according to claim 28, wherein the controller is adapted to carry out a different management on the same image data depending on the information.

30. The watching system according to claim 28, wherein the information acquired by acquisition equipment is the difference between daytime or nighttime.

31. The watching system according to claim 30, wherein the controller is adapted to carry out the management on a predetermined image data only when the information represents nighttime.

32. The watching system according to claim 31, wherein the management is a report to one of police or a secure company.

33. The watching system according to claim 28, further comprising a monitor that displays the image data.

34. A watching system comprising:
a watching camera that takes pictures of a field to output image data;
a detector that detects whether or not anyone is at home; and
a controller that carries out a management against a danger depending on the image data of the watching camera and the detection by the detector.

35. The watching system according to claim 34, wherein the controller is adapted to carry out a different management on the same image data depending on the detection.
